(19) United States
(12) Patent Application Publication
(10) Pub. No.: US 2023/0081947 A1
(43) Pub. Date: Mar. 16, 2023

(54) A COMPACTOR

(71) Applicant: Bill CREGAN, Dublin (IE)

(72) Inventor: Bill CREGAN, Dublin (IE)

(21) Appl. No.: 17/799,781

(22) PCT Filed: Feb. 12, 2021
(86) PCT No.: PCT/EP2021/053546

§ 371 Date: Aug. 15, 2022

(30) Foreign Application Priority Data
Feb. 14, 2020 (GB) 2002049.1

(51) Int. Cl. B30B 9/30; B65F 1/14

(52) U.S. Cl. CPC B30B 9/3032; B30B 9/3007; B30B 9/3021; B30B 9/3046; B30B 9/3057; B65F 1/1405

(57) ABSTRACT

A compactor (1) for waste material comprises a housing (3) for receipt of a bag (4), the housing comprising sidewalls (11, 12) including at least one openable sidewall (13), and a compacting press comprising an actuator to force material into the bag when it is housed in the housing. At least one of the sidewalls comprises two adjacent panels (14, 15) connected by articulation means (16) allowing the sidewall to fold during a compaction operation. The folding of the sidewall has been found to dissipate the stresses caused by the pressure in the bag/housing due to the changing geometry and the movement of waste material into regions of lower density or voids created by the changed geometry.

### FIELD OF THE INVENTION

The present invention relates to a compactor for material such as waste, and a method for compacting material such as waste

### BACKGROUND TO THE INVENTION

In a generic compaction system, the material is forced into a rigid container. The material compaction is restricted by the available volume and the direction of the compressive force. There must be adequate pressure for the compaction process to overcome material density and sufficient pressure applied to continue to overcome the frictional forces of deposited material and possibly the accumulated material already deposited in the container. This is illustrated in FIG. 1 (Prior art).

WO2018/029079 describes a waste compactor system comprising a housing for receipt of a bag, the housing comprising opposed side walls, and a compacting press comprising an actuator to force material into the bag when it is housed in the housing. The opposed sidewalls are fixed to the base of the housing and are resiliently deformable allowing the sidewalls to deflect outwardly when the pressure in the bag/housing increases. This would create a scenario whereby material wouldn't be bordered with a plumb wall but a wall that was now at an incline relative to the amount of pressure created. The material now could expand into this newly created region for a long as the pressure was sufficient to maintain the deflection. In addition, the newly created angle was a slope. This meant the energy required for the material to climb/expand was proportionally reduced when compared being contained by static a plumb wall.

A number of problems exist with this system. First, sufficient force must be applied before there is a deformation. The materials characteristics will have a significant impact on the rate of deformation and the force required causing the wall deflection. (e.g. deflection and elastic limits will be different for 2 mm steel as opposed to 6 mm steel or if you were to use plastic instead of steel, the values would be completely different). Hence there may-be a situation where material entering the containment unit will be of such low density or other characteristics that the material will not be capable of transferring an applied force to cause any deformation. In addition, the deflected walls try to return to the original position once the pressure is removed, however; continual deformation can cause fatigue in the material. (The continual flexing of the walls can cause work hardening of the material and change the ductility. This is especially true under cyclical or high frequency loading). The continual deformation can result in a change in the materials behavioural characteristics, i.e. the material may not return to its point of origin/home position, when the pressure is removed. (this is referred to as plastic deformation, where the material goes beyond the elastic limit and cannot return to its original shape). Moreover, the risk of permanent deformation is also increased when the system is held under load for extended periods of time.

It is an object of the invention to overcome at least one of the above-referenced problems.

### SUMMARY OF THE INVENTION

The Applicant has addressed the problems of the prior art by providing a compactor having a housing with a sidewall that is configured to fold during a compaction operation to change the geometry of the housing according to the pressures encountered. The folding of the sidewall has been found to dissipate the stresses caused by the pressure in the bag/housing due to the changing geometry and the movement of waste material into regions of lower density or voids created by the changed geometry.

In a first aspect, the invention provides a compactor for waste material comprising:

a housing for receipt of a bag, the housing comprising sidewalls including at least one openable sidewall; and

a compacting press comprising an actuator to force material into the bag when it is housed in the housing, characterised in that at least one of the sidewalls comprises two adjacent panels connected by articulation means allowing the at least one sidewall to fold during a compaction operation.

The at least one sidewall is generally configured to fold along a vertical axis. The at least one sidewall is generally configured to fold outwardly.

In one embodiment, at least two of the sidewalls comprise two adjacent panels connected by articulation means allowing the at least two sidewalls to fold during a compaction operation.

In one embodiment, the housing comprises two opposed sidewalls.

Preferably, the two opposed sidewalls each comprise two adjacent panels connected by articulation means allowing both sidewalls to fold during a compaction operation.

In one embodiment, the openable sidewall is disposed facing the compacting press. In one embodiment, the openable sidewall is flanked on each side by the opposed sidewalls.

In one embodiment, the openable sidewall is configured to fold during a compaction operation.

In one embodiment, the openable sidewall comprises two interconnected panels each hingedly connected to an adjacent sidewall for opening and closing of the openable sidewall. In one embodiment, the openable sidewall comprises means for locking the openable sidewall in a closed configuration. In one embodiment, the locking means is configured to allow folding of the openable sidewall when it is in a closed configuration.

In one embodiment, the housing comprises a front wall fixed to the compacting press and having an aperture for receipt of waste from the compacting press, in which at least one side wall is connected to the front wall by articulation means.

In one embodiment, at least one, and preferably two sidewalls are connected to the front wall by articulation means.

In one embodiment, the housing comprises:

a front wall fixed to (or forming part of) the compacting press and having an aperture for receipt of waste from the compacting press;

two sidewalls at least one of which comprises two adjacent panels connected by articulation means allowing the at least one sidewall to fold during a compaction operation; and an openable sidewall facing the front wall and comprising two interconnected panels, each of which is connected to an adjacent sidewall by articulation means.

In one embodiment, the housing comprises a front wall, at least two sidewalls, and an openable sidewall facing the front wall.

In one embodiment, the housing comprises a plurality of bag mounting hooks disposed around a periphery of the housing.

In one embodiment, the hooks are configured for rotation relative to the housing about an axis parallel to a panel articulation axis.

In one embodiment, the bag mounting hooks comprise tensioning means configured to lower the suspended bag as the weight in the bag increases.

In one embodiment, the bag mounting hooks comprise a support arm, a hook arm hingedly connected to the support arm for movement between first and second bag tensioning positions, and a tensioning spring mounted between the support arm and hook arm.

In one embodiment, the bag mounting hooks comprise bag weighing means.

In one embodiment, the actuator comprises opposed rams and a frame for connecting the opposed rams, in which each ram comprises a cylinder and a piston configured for movement in or out of the cylinder upon actuation.

In one embodiment, the frame for connecting the rams comprises:

a central plate having an aperture for receiving the cylinders;

a first connecting element for mounting to an end of the first cylinder;

a second connecting element for mounting to an end of the second cylinder;

first coupling means for coupling the first connecting element to the central plate;

and second coupling means for coupling the second connecting element to the central plate.

In one embodiment, the first and second coupling means are adjustable to vary the distance between the central plate and the connecting elements.

In one embodiment, each coupling means comprises two spaced apart parallel connecting rods configured to be disposed in use on opposite sides of the cylinder.

In one embodiment, each connecting rod comprises a threaded bolt and nut assembly.

In one embodiment, the connecting elements each comprise two L-shaped brackets each having a foot part and a stem part, and a connecting bolt, wherein the stem parts have through-holes for receipt of the connecting bolt.

In one embodiment, the compactor comprises a sensor for monitoring the change in geometry of the housing during a compaction operation. For example, a sensor could be incorporated into the articulation means of one or more sidewalls to monitor folding of the one or more sidewalls. Alternatively, the compactor may include a camera configured to visually monitor and determine changes in geometry of the housing.

In one embodiment, the compactor comprises a sensor for measuring the weight of the bag during a compaction operation.

In another aspect, the invention provides a method of compacting waste that employs a compactor of the invention, the method comprising the steps of:

placing a bag into the housing, in which the bag comprises an opening (generally disposed on a side of the bag) configured to mate with an outlet of the compactor press housing for receipt of waste material during a compaction operation;

coupling the opening of the bag with the outlet of the compactor press housing; and

actuating the compaction press to perform a compaction operation.

In another aspect, the invention provides a system comprising:

a compactor for waste according to the invention, in which the compactor comprises first sensing means for monitoring the change in geometry of the housing during a compaction operation and a controller for controlling actuation of the compacting press;

a processor in electronic communication with the first sensing means and the controller for the compacting press, and configured to receive data relating to the geometry of the housing during a compaction operation, compare the received geometry data with reference geometry data, and actuate the controller based on the comparison.

In one embodiment, the processor is configured to stop compaction when the geometry of the housing matches a first reference geometry.

In one embodiment, the processor is configured to increase compaction force or rate when the geometry of the housing matches a second reference geometry.

In one embodiment, the compactor includes a second sensing means for determining the weight of waste in the bag in electronic communication with the processor, and in which the processor is configured to calculate the density of material in the bag based on the weight and geometry of the housing sensed by the first and second sensors, compare the density of the material with reference material density data, and actuate the controller based on the comparison.

In one embodiment, the processor is configured to stop compaction when the calculated density of the material in the bag reaches or exceeds a first reference density.

In one embodiment, the processor is configured to increase compaction force or rate when the calculated density of the material in the bag is below a second reference density.

In another aspect, the invention provides a method of compacting waste that employs a compactor comprising:

a housing for receipt of a bag, the housing comprising side walls; and

a compacting press comprising an actuator to force material into the bag when it is housed in the housing, the method comprising the steps of actuating the compaction press to perform a compaction operation;

determining the weight of the waste material in the bag at least once during the compaction operation;

determining the geometry of the housing at the same time as the weight is determined;

calculating the density of the material in the bag based on the weight of waste material in the bag and geometry of the housing; and

stopping the compaction operation if the density of the material in the bag exceeds a threshold density.

In one embodiment, the compactor is a compactor according to the invention.

Generally, the weight and geometry are measured at a plurality of time points during the compaction operation.

In another aspect, the invention provides a frame forming part of a linear actuator and for operably connecting opposed rams of the linear actuator, in which each ram of the linear actuator comprises a cylinder and a piston configured for movement in or out of the cylinder upon actuation, the frame comprising:

a central plate having an aperture for receiving the cylinders;

a first connecting element for mounting to an end of the first cylinder;

a second connecting element for mounting to an end of the second cylinder;

first coupling means for coupling the first connecting element to the central plate;

and second coupling means for coupling the second connecting element to the central plate.

In one embodiment, the first and second coupling means are adjustable to vary the distance between the central plate and the connecting elements.

In one embodiment, each coupling means comprises two spaced apart parallel connecting rods configured to be disposed in use on opposite sides of the cylinder.

In one embodiment, each connecting rod comprises a threaded bolt and nut assembly.

In one embodiment, the connecting elements each comprise two L-shaped brackets each having a foot part and a stem part, and a connecting bolt, wherein the stem parts have through-holes for receipt of the connecting bolt.

In another aspect, the invention provides a linear actuator comprising two opposed rams operably connected with a frame according to the invention.

In another aspect, the invention provides a compactor for waste material comprising:

a housing for receipt of a bag, the housing comprising side walls; and

a compacting press comprising an actuator to force material into the bag when it is housed in the housing, characterised in that the housing comprises a plurality of bag mounting hooks disposed around a periphery of the housing for suspending the bag within the housing.

In one embodiment, the bag mounting hooks comprise tensioning means configured to lower the suspended bag as the weight in the bag increases.

In one embodiment, the bag mounting hooks comprise a support arm, a hook arm hingedly connected to the support arm for movement between first and second bag tensioning positions, and a tensioning spring mounted between the support arm and hook arm.

In one embodiment, the actuator comprises opposed rams and a frame for connecting the opposed rams, in which each ram comprises a cylinder and a piston configured for movement in or out of the cylinder upon actuation.

Other aspects and preferred embodiments of the invention are defined and described in the other claims set out below.

### BRIEF DESCRIPTION OF THE FIGURES

FIG. 1 (Prior art) illustrates a conventional compactor with a rigid container.

FIG. 2 is a perspective view of a compactor according to the invention;

FIG. 3 is another perspective view of the compactor of FIG. 2;

FIG. 4 is a top plan view of the compactor of FIG. 2 with a bag in-situ and prior to start of a compaction operation;

FIGS. 5, 6 and 7 are top plan views of the compactor of FIG. 2 with a bag in-situ and during a compaction operation;

FIG. 8 is another top plan view of the compactor of FIG. 2 prior to start of a compaction operation;

FIG. 9 is another top plan view of the compactor of FIG. 2 during a compaction operation;

FIG. 10 is another top plan view of the compactor of FIG. 2 at the completion of a compaction operation;

FIGS. 11 and 12 are pictures of cuboid bags filled with waste using a compactor of the invention;

FIG. 13 is a side elevational view of bag mounting and tensioning device forming part of the compactor of the invention;

FIG. 14 is a rear elevational view the bag mounting and tensioning device looking in the direction of arrow A of FIG. 13;

FIG. 15 is a top plan view of the bag mounting and tensioning device of FIG. 13;

FIG. 16 is a perspective view of a frame for a linear actuator according to the invention;

FIG. 17 is a top plan view of the frame of FIG. 16;

FIG. 18 is a side elevational view of the frame of FIG. 16;

FIGS. 19 and 20 are a perspective views of a linear actuator according to the invention;

FIG. 21 is a top plan view of the linear actuator of FIG. 19; and

FIG. 22 is an end elevational view of the frame of FIG. 19.

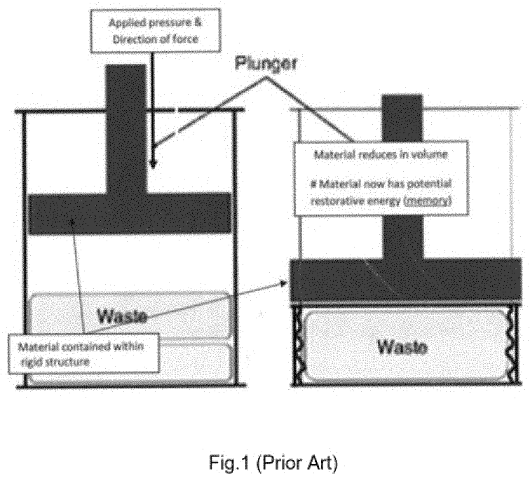

### DETAILED DESCRIPTION OF THE INVENTION

All publications, patents, patent applications and other references mentioned herein are hereby incorporated by reference in their entireties for all purposes as if each individual publication, patent or patent application were specifically and individually indicated to be incorporated by reference and the content thereof recited in full.

### Definitions and General Preferences

Where used herein and unless specifically indicated otherwise, the following terms are intended to have the following meanings in addition to any broader (or narrower) meanings the terms might enjoy in the art:

Unless otherwise required by context, the use herein of the singular is to be read to include the plural and vice versa. The term “a” or “an” used in relation to an entity is to be read to refer to one or more of that entity. As such, the terms “a” (or “an”), “one or more,” and “at least one” are used interchangeably herein.

As used herein, the term “comprise,” or variations thereof such as “comprises” or “comprising,” are to be read to indicate the inclusion of any recited integer (e.g. a feature, element, characteristic, property, method/process step or limitation) or group of integers (e.g. features, element, characteristics, properties, method/process steps or limitations) but not the exclusion of any other integer or group of integers. Thus, as used herein the term “comprising” is inclusive or open-ended and does not exclude additional, unrecited integers or method/process steps.

### Exemplification

The invention will now be described with reference to specific Examples. These are merely exemplary and for illustrative purposes only: they are not intended to be limiting in any way to the scope of the monopoly claimed or to the invention described. These examples constitute the best mode currently contemplated for practicing the invention.

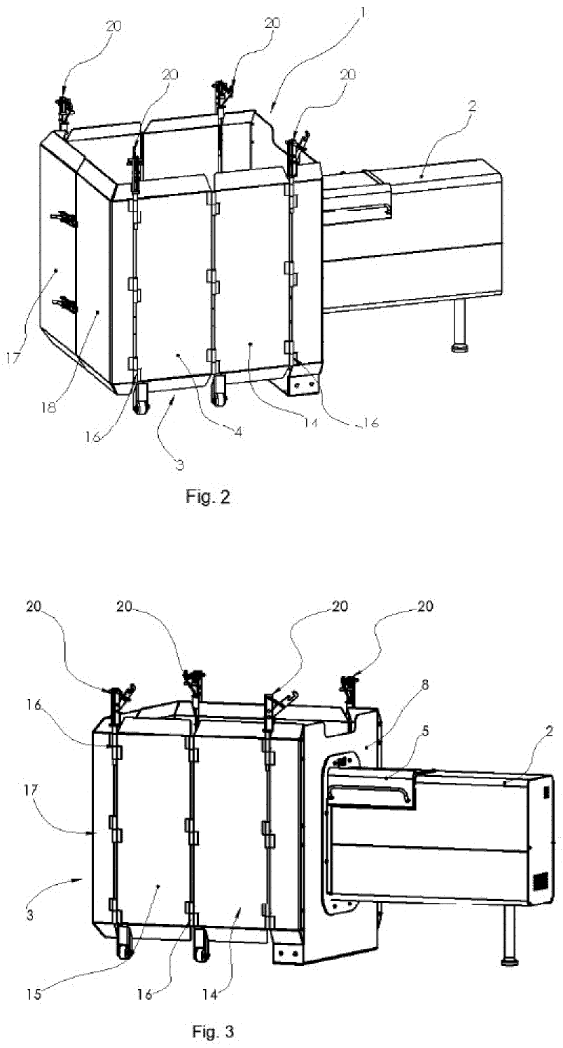

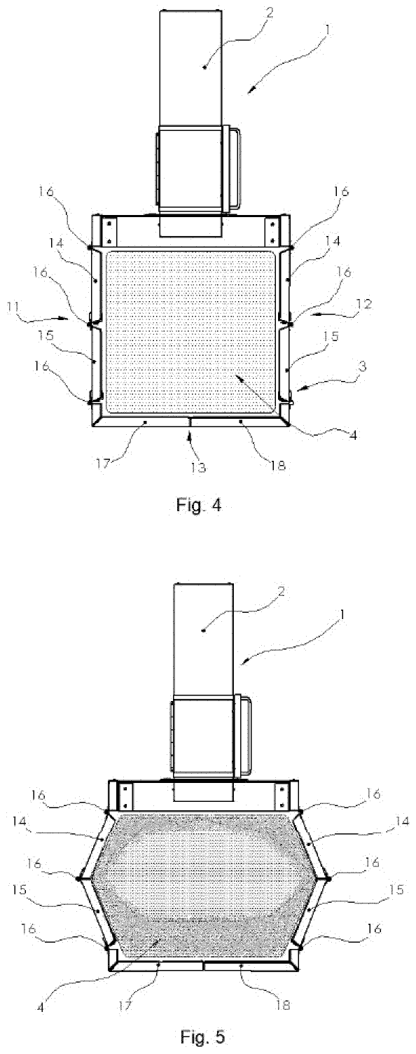

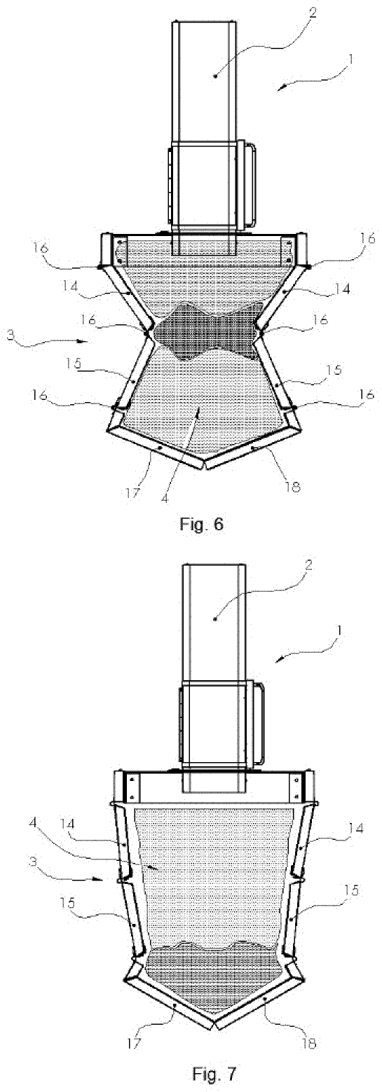

Referring to the figures, and initially to FIGS. 2 to 7, there is provided a compactor indicated generally by the reference numeral 1 and comprising a compactor press housing 2 and a housing 3 containing a bag 4 for receipt of waste material. The compactor housing 2 containing a compactor press (not shown) and an actuator (described below), and an openable hatch 5 for placing waste material in the housing 2 distally of the compactor press. Upon actuation of the press, waste material is forced through an aperture (not shown) in a front wall 8 of the housing 3 and into the bag 4 disposed in the housing.

In more detail, the housing 3 is defined by the front wall 8 of the housing 3, and a sidewall comprising a plurality of panels configured to allow the sidewall fold during a compaction operation (as shown in FIGS. 5 to 7). In this embodiment, the sidewall comprises opposed sidewall sections 11 and 12, and a rear sidewall section 13. Each of the opposed sidewall sections 11 and 12 comprise two panels 14 and 15 interconnected by articulation means 16 allowing pivoting movement of the panels. Panels 14 are connected to the front wall 8 by articulation means 16 allowing pivoting movement of the panels 14 relative to the fixed front wall 8. The rear sidewall section 13 comprises panels 17 and 18, each of which is pivotally connected to a panel 15 by articulation means 16 allowing pivoting movement between the panels along a vertical articulation axis.

The rear sidewall section 13 of the housing comprises a detachable coupling (not shown) which maintains the panels 17 and 18 in a closed configuration during a compaction operation but allows the panels to be opened for insertion or removal of a bag.

The bags employed with the compactor are generally cuboid as illustrated in FIGS. 11 and 12, and will usually include a neck section 19 on a side of the bag that is configured to mate with an outlet of the compactor press housing for receipt of waste material during a compaction operation.

The provision of a housing sidewall in the form of a plurality of interconnected and articulated panels allows the sidewall to fold in response to pressures exerted on the bag/housing, to change the geometry of the housing during compaction and dynamically change the pressure points within the bag facilitating distribution of waste material throughout he bag.

The articulated panels shown in the example figures may assume several orientations during any one compaction cycle. The Figures: 4, 5, 6, 7 and 10 are visual aids to demonstrate the effect the changing geometry has on the material contained within the housing.

As the panels articulate, the less dense material shown as light grey diagonal lines moves or releases energy. In situations where the geometry is conducive to compression, the material converges and/or is compressed, shown as a solid darker grey.

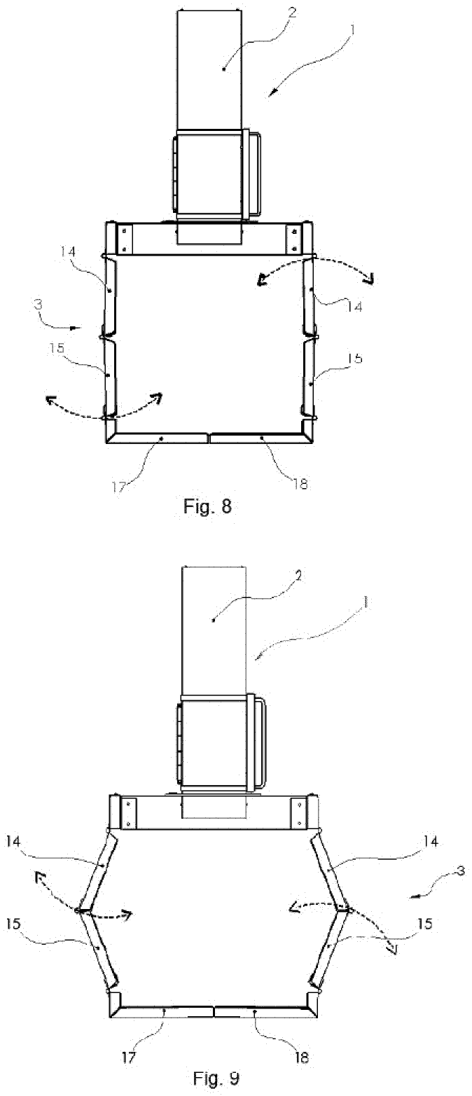

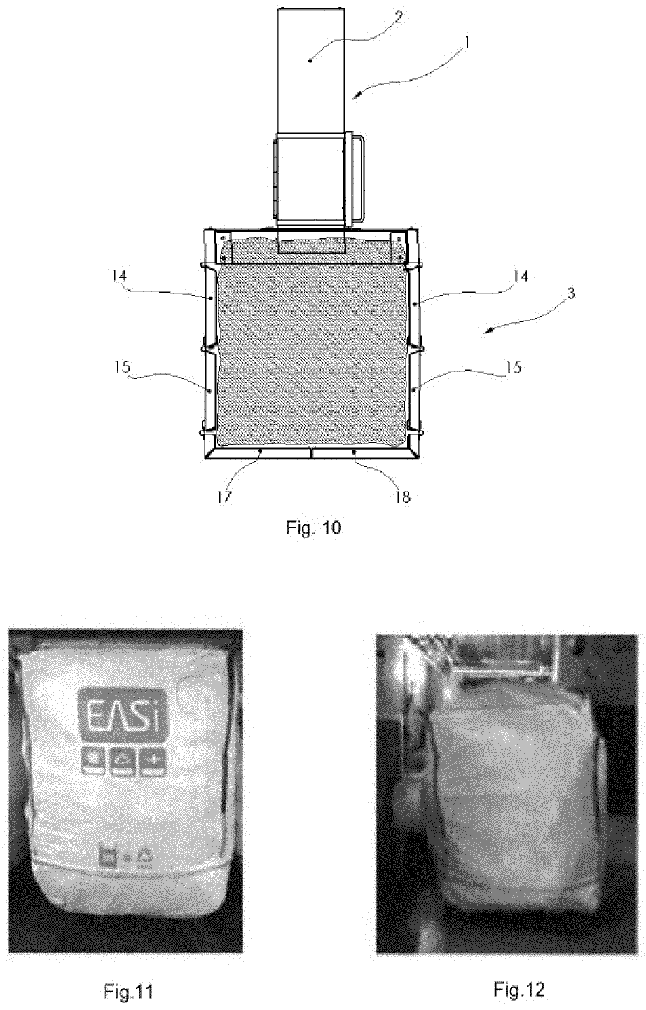

Figures. 8 and 9 are shown with curved dashed lines running through a central line of an articulated section. This is a visualisation aid to demonstrate some of the degrees of freedom for a panel.

Figures. 11 and 12 are bag cuboids produced by utilising the articulated compaction system.

Figure: 5 Illustrates the redistribution of pressure and restorative energy in the material. The panels articulate outwards. The change in geometry of the housing is as a result of the pressure applied from the compaction piston and the restorative effect of the material prior, during and post compaction.

The housing expands and compaction force is applied to the material in close proximity to panels 17 and 18, while also applying pressure to neighbouring material. Were the panels articulate in response to the applied pressure, there is a subsequent drop in pressure in that region.

Figure: 6 Illustrates how articulation inwards results in a compressive force being applied. The material is subject to squeezing. The material outside this region will escape and/or release energy into regions outside the squeezed zone.

Figure: 7 Illustrates how applying pressure towards panels 17 and 18, the subsequent change in geometry now results in the material converging and being focused into a region of higher compaction (were higher compressive values can be achieved)

Figures: 8 & 9 are some examples of the articulation and the radial path a panel can take.

Figure: 10: the darker grey colour represents material of a uniform or compacted value. With uniform/compacted values applied to the panels, there is a restorative effect on the housing geometry and it returns to an initial form. The material in the bag which is contained within housing is now compacted.

FIGS. 11 and 12 (images) are examples of material compacted into cuboids.

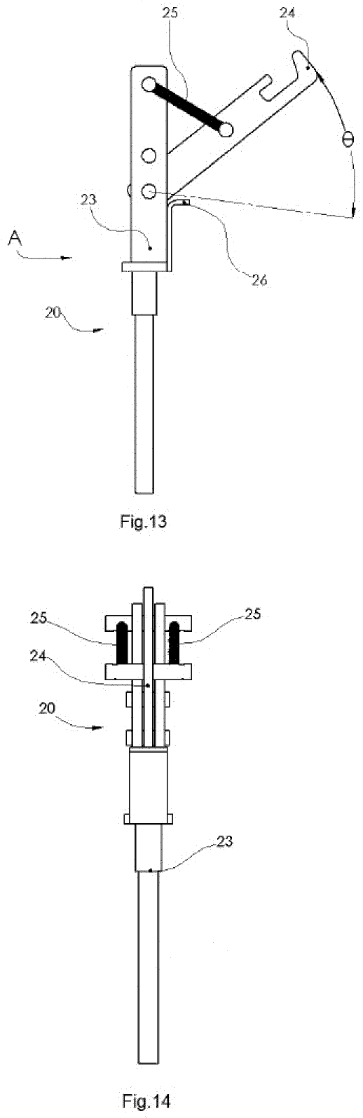

In one embodiment, the bag 4 is suspended in the housing 3 by suspension and tensioning elements 20 disposed around a periphery of the housing 3 as shown in FIG. 2. These elements are used to support the bag, and also to tension the bag by allowing the bag to be suspended from the sidewall of the compactor initially, and then lowered as the weight of the bag increases. Suspending the bag during a compaction operation helps open the bag up and tension the bag, allowing for easier filling of the bag. Referring to FIGS. 13 to 15, the elements 20 comprise a support arm 23, a bag suspension arm 24 hingedly attached to the support arm 23 for pivotal movement from a first bag supporting configuration (raised) to a second bag supporting configuration (lowered) through an angle ø (preferably, the bag suspension arm is configured for movement through a sweep of about 50° from an angle of about 40° to the vertical to an angle of about 100° to the vertical), and tensioning springs 25 mounted between the support and suspension arms. A stop 26 is provided to limit the range of movement of the suspension arm. The elements are mounted to the sidewall of the housing at the articulation points between the panels at the four corners of the housing, and are free to rotate about, and move with, the articulation axis.

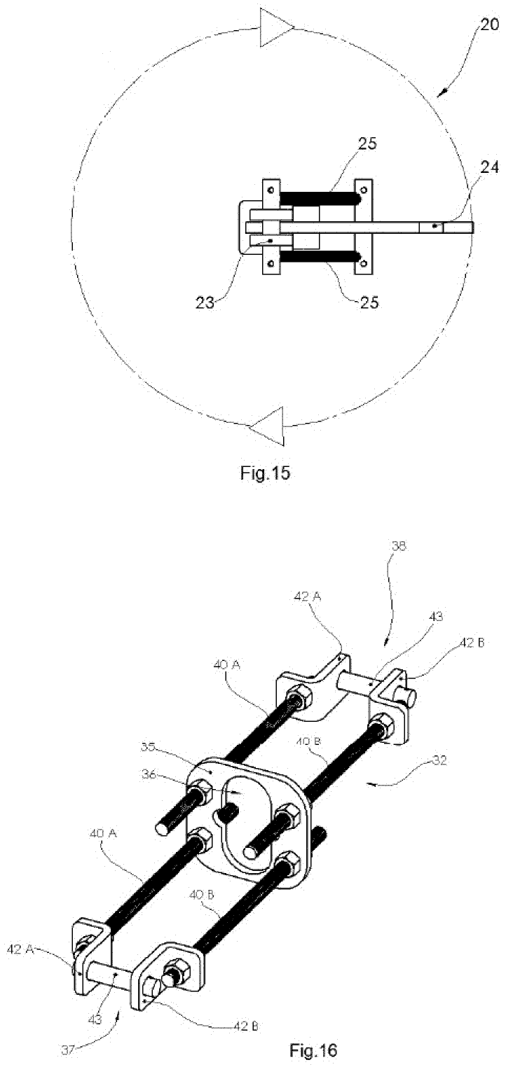

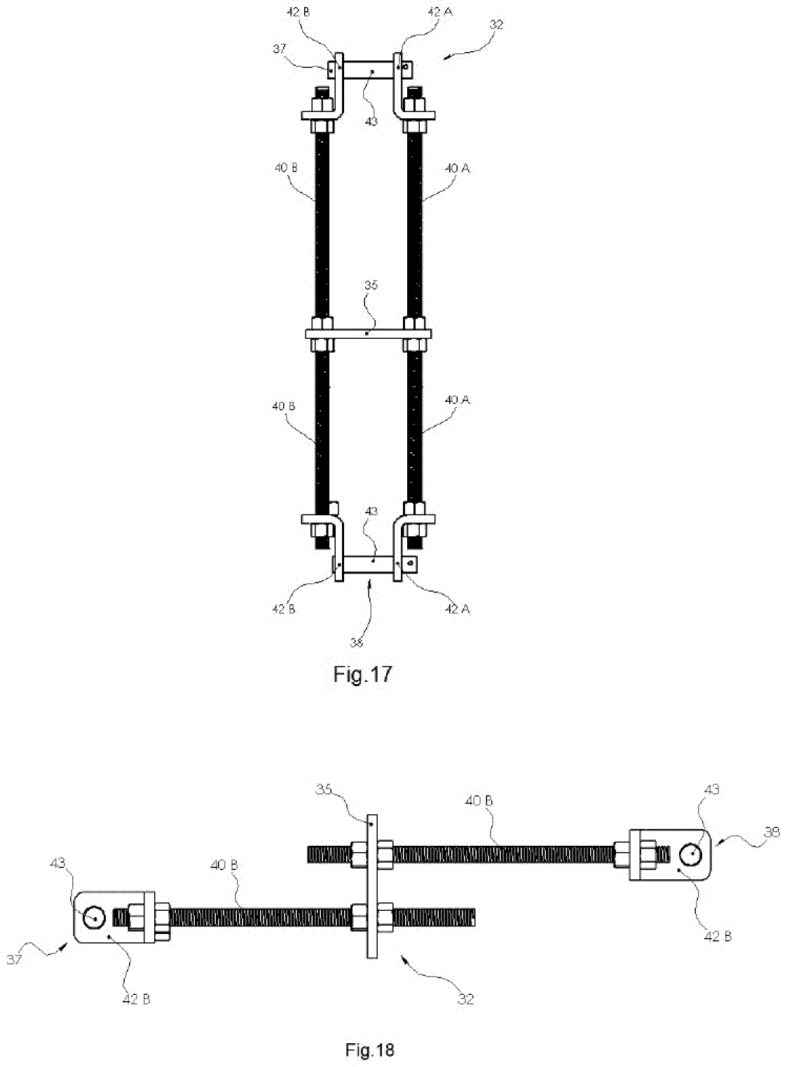

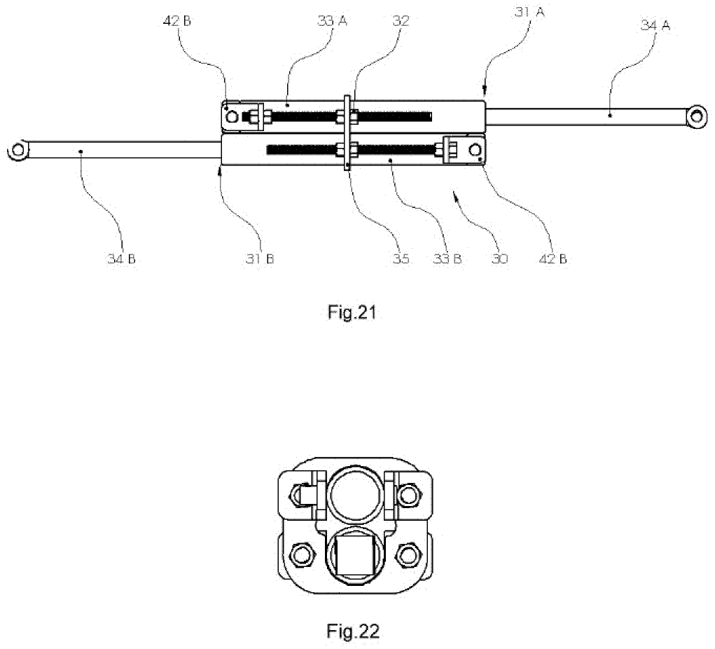

Referring to FIGS. 16 to 22, an actuator forming part of the compactor of the invention and indicated generally by the reference numeral 30 is described. The actuator comprises opposed rams 31A and 31B operably connected by a frame 32. Each ram comprises a cylinder 33A and 33B and a piston 34A and 34B.

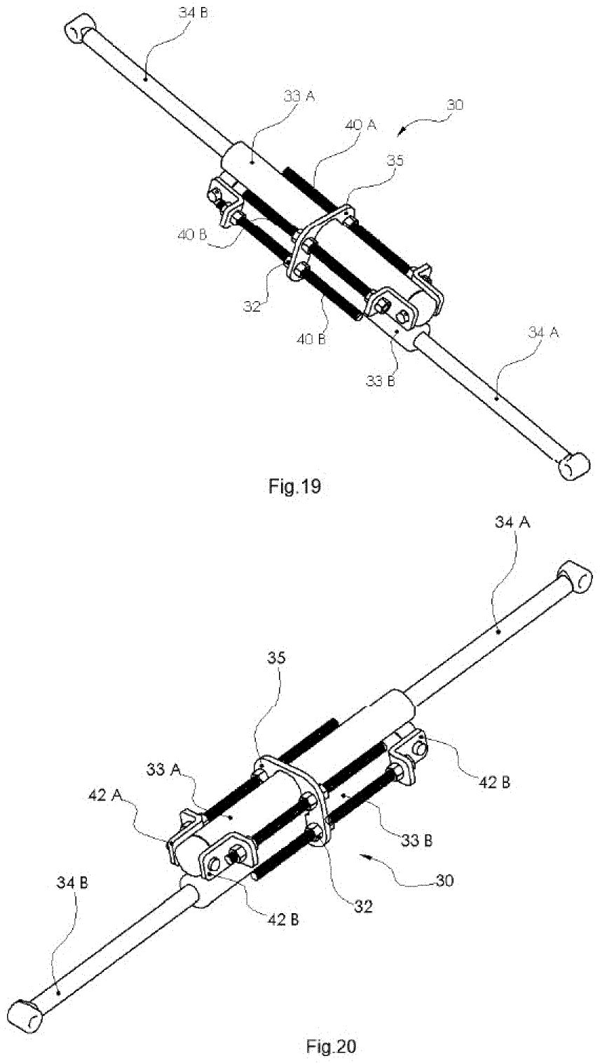

Referring initially to FIGS. 16 to 18, the frame 32 comprises a central plate 35 having an aperture 36 dimensioned to receive the cylinders in a side-by-side configuration, a first connecting element 37 for mounting to an end of the first cylinder 33A, a second connecting element 38 for mounting to an end of the second cylinder 33B, first coupling means for coupling the first connecting element 37 to the central plate 35, and second coupling means for coupling the second connecting element 38 to the central plate 35. The first and second coupling means are adjustable to vary the distance between the central plate and the connecting elements and are composed of two spaced apart parallel threaded bolts 40A, 40B configured to be disposed in use on opposite sides of the cylinder. Each connecting 37, 38 comprises two L-shaped brackets 42A, 42B each having a foot part and a stem part, and a connecting bolt 43 dimensioned pass through a through hole on the stem of each bracket and a through hole in the end of the cylinder to clamp the brackets on each side of the cylinder. FIGS. 19 to 22 show the frame 32 operably connected to opposed rams 31A, 31B.

The compactor of the invention doesn't operate using deformation of the structural wall but is designed to allow the material to expand and become bulbous or whatever shape the material density predetermines. This is because the folding sidewall acts like a chain rope that envelops the material. The folding sidewall takes a path of least resistance as pressure is exerted much like the links in a taut chain as it wraps, rotates and pivots around an object's perimeter.

The profile geometry of the folding sidewall is determined by the material entering the containment area. Therefore, material entering can have a unique condition all depending on the previous wall orientation. There is no resistance from the walls to rotate around the axis. The walls articulate around an axis and also the axis is not fixed in a single location but also located on a radial axis (articulated axis). The benefits of this are the behavioural characteristics of the linked walls acting in different orientations. The walls can act in unison, groups or individually depending on the reaction conditions of the material contained, so the material inside can be deflected, compressed, re-orientated into lower/higher pressure regions. The movement in the axis is the rotational equivalent of linear force, which can be visualised as a lever. With a lever, the further the distance that the force is applied from the fulcrum, the less force required to make it move. It is the most efficient use of applied work.

The walls act like a lever that take the force and rotate around the axis to envelop the material applying the pressure. The efficiency of the system (mechanical advantage) is dependent on where the distance from the fulcrum(s) where the force is applied, but as the system is not overcoming elastic resistance, the energy out from the material is the compress energy in balancing the system. It is the most efficient use of applied work.

Because the system articulates, it's not under stress; it's designed to dissipate the stress through the changing geometry of the perimeter.

The deflection on an axis doesn't require a force to maintain deformation, it not deformation its axial plains moving and the movement in the axial planes create volume, new paths and compaction/release pressure. It is in the continual combination of the compressive forces and the manipulation of the geometry that the material memory is removed. This results in a very efficient compaction method. The material entering into the system is compacted when it meets a surface or in-situ material that was previously deposited. The amassed as well as the newly added material will expand/move into regions of lower density or available voids and as the planer surfaces cater for the movement. There will be lower frictional resistance to overcome in the positive compaction cycle. This is also true when the compressive force is removed and the material memory is looking to expand and dissipate the gained energy.

### EQUIVALENTS

The foregoing description details presently preferred embodiments of the present invention. Numerous modifications and variations in practice thereof are expected to occur to those skilled in the art upon consideration of these descriptions. Those modifications and variations are intended to be encompassed within the claims appended hereto.

1. A compactor (1) for waste material comprising:
a housing (3) for receipt of a bag, the housing comprising sidewalls (11, 12, 13) including at least one openable sidewall (13); and
a compacting press comprising an actuator (30) to force material into the bag when it is housed in the housing,
characterised in that at least one of the sidewalls (11, 12) comprises two adjacent panels (14, 15) connected by articulation means (16) allowing the at least one sidewall to fold during a compaction operation.

2. The compactor according to claim 1, in which the housing comprises at least two sidewalls (11, 12) each comprising two adjacent panels (14, 15) connected by articulation means (16) allowing the two sidewalls to fold during a compaction operation.

3. The compactor according to claim 2, in which the two foldable sidewalls (11, 12) are opposed sidewalls.

4. The compactor according to claim 3, in which the openable sidewall (13) is disposed in between the opposed sidewalls (11, 12).

5. The compactor according to claim 1, in which the openable sidewall (13) is configured to fold while remaining closed during a compaction operation.

6. The compactor according to claim 1, in which at least two of the sidewalls are connected together by articulation means to allow the at least two sidewalls fold during a compaction operation.

7. The compactor according to claim 1, in which the housing (3) comprises a front wall (8) fixed to or forming part of the compacting press and having an aperture for receipt of waste from the compacting press, in which at least one sidewall (11, 12) is connected to the front wall by articulation means.

8. The compactor according to claim 7, in which two sidewalls are connected to the front wall by articulation means.

9. The compactor according to claim 1 and comprising
a front wall (8) fixed to the compacting press and having an aperture for receipt of waste from the compacting press;
two sidewalls (11, 12) at least one of which comprising two adjacent panels (14, 15) connected by articulation means (16) allowing the at least one sidewall to fold during a compaction operation; and
an openable sidewall (13) disposed between and connected to the sidewalls (11, 12) by articulation means.

10. The compactor according to claim 1 in which the openable sidewall (13) is disposed facing the front wall (8).

11. The compactor according to claim 1, in which the housing comprises a plurality of bag mounting hooks (20) disposed around a periphery of the housing (3) configured to suspend a bag over a base of the housing during a compacting operation.

12. The compactor according to claim 11, in which the bag mounting hooks (20) are configured for rotation relative to the housing (3) about a vertical axis.

13. The compactor according to claim 12, in which the bag mounting hooks (20) comprise tensioning means configured to lower the suspended bag as the weight in the bag increases.

14. The compactor according to claim 13, in which the bag mounting hooks (20) comprise a support arm (23), a hook arm (24) connected to the support arm for pivotal movement between first and second bag tensioning positions, and a tensioning spring (25) mounted between the support arm and hook arm.

15. The compactor according to claim 12, in which the actuator (30) comprises opposed rams (31A, 31B) and a frame (32) for connecting the opposed rams, in which each ram comprises a cylinder (33A, 33B) and a piston (34A, 34B) configured for movement in or out of the cylinder upon actuation.

16. The compactor according to claim 15, in which the frame for connecting the rams comprises:
a central plate (35) having an aperture (36) for receiving the cylinders in a side-by-side relationship;
a first connecting element (37) for mounting to an end of the first cylinder; a second connecting element (38) for mounting to an end of the second cylinder;
first coupling means for coupling the first connecting element to the central plate; and
second coupling means for coupling the second connecting element to the central plate.

17. The compactor according to claim 16, in which the first and second coupling means are adjustable to vary the distance between the central plate and the connecting elements.

18. A compactor according to claim 17, in which each coupling means comprises two spaced apart parallel connecting rods (40A, 40B) configured to be disposed in use on opposite sides of a cylinder (33A, 33B), and in which each connecting rod (40A, 40B) comprises a threaded bolt and nut assembly.

19-22. (canceled)

23. A system for controlled compaction of waste, comprising:
a compactor for waste, comprising:
a housing (3) for receipt of a bag, the housing comprising sidewalls (11, 12, 13) including at least one openable sidewall (13); and
a compacting press comprising an actuator (30) to force material into the bag when it is housed in the housing,
characterised in that at least one of the sidewalls (11, 12) comprises two adjacent panels (14, 15) connected by articulation means (16) allowing the at least one sidewall to fold during a compaction operation,
in which the housing comprises a plurality of bag mounting hooks (20) disposed around a periphery of the housing (3) configured to suspend a bag over a base of the housing during a compacting operation . . . . in which the bag mounting hooks (20) are configured for rotation relative to the housing (3) about a vertical axis,
further comprising a housing geometry sensor for monitoring the change in geometry of the housing during a compaction operation,
and a controller for controlling actuation of the compacting press; and
a processor in electronic communication with the housing geometry sensor and the controller for the compacting press, and configured to receive data relating to the geometry of the housing during a compaction operation, compare the received geometry data with reference geometry data, and actuate the controller based on the comparison.

24. The system according to claim 23, in which the processor is configured to stop compaction when the geometry of the housing matches a first reference geometry and in which the processor is configured to increase compaction force or rate when the geometry of the housing matches a second reference geometry.

25-36. (canceled)
